(19) United States
(12) Patent Application Publication
(10) Pub. No.: US 2018/0003108 A1
(43) Pub. Date: Jan. 4, 2018

(54) SOUND INSULATION STRUCTURE OF INTERNAL COMBUSTION ENGINE

(71) Applicant: HONDA MOTOR CO., LTD., Tokyo (JP)

(72) Inventors: Shota Fujimura, Wako-shi, Saitama (JP); Hiroshi Nagashima, Wako-shi, Saitama (JP)

(21) Appl. No.: 15/545,449

(22) PCT Filed: Jan. 28, 2016
(86) PCT No.: PCT/JP2016/000440

§ 371 Date: Jul. 21, 2017

(30) Foreign Application Priority Data
Feb. 2, 2015 (JP) 2015-018283

(51) Int. Cl. F02B 77/13; F02M 61/16; F02M 55/02; F02B 77/11; F02F 7/00; B60R 13/08

(52) U.S. Cl. CPC F02B 77/13; F02M 55/02; F02B 77/11; F02M 61/16; B60R 13/0884; B60R 13/0838; F02F 7/008

(57) ABSTRACT

Provided is a sound insulation structure for an internal combustion engine that facilitates the assembly work, and minimizes the transmission vibrations and noises. The sound insulation structure for an internal combustion engine comprises a cover main body (21) disposed outside of a main body (10) of the internal combustion engine and covering at least a part of the engine main body, and a foam sound insulation member (22) made of a foam material and attached to an inner surface (21a) of the cover main body facing the engine main body. The foam sound insulation member covers a noise source (11) of the engine main body and abuts the engine main body or a component part (12, 14) attached to the engine main body at an outer periphery thereof so as to interpose the noise source. The engine main body or the component part includes a sound insulation wall (31-33) projecting therefrom so as to shield a junction part at which the foam sound insulation member abuts or adjoins the engine main body or the component part thereof and the sound insulation wall is covered by the cover main body.

### TECHNICAL FIELD

The present invention relates to a sound insulation structure of an internal combustion engine having a cover main body and a foam sound insulation member.

### BACKGROUND OF THE INVENTION

As a technology for reducing the noise of an internal combustion engine, it is known, for example, to cover a plurality of high pressure pipes connecting a common rail to respective fuel injection nozzles from outside with a sound insulation member so as to fill the space defined between the adjoining high pressure pipes with this sound insulation member (see Patent Document 1).

It is also known to cover an area extending from a cylinder head cover of an engine to a fuel injection pump positioned in a front part of a vehicle body with an outer sound insulation cover consisting of an outer cover member made of plastic material and an inner sound insulation member made of polyurethane and fixedly attached to the inner surface of the outer cover member, from above (see Patent Document 2). The sound insulation structure disclosed in Patent Document 2 is configured such that the sound insulation cover covers a high pressure pipe such as a common rail from above, and one end of the inner sound insulation member contacts a cooling water pipe while the other end of the inner sound insulation member contacts the cylinder head cover.

### PRIOR ART DOCUMENT(S)

### Patent Document(s)

Patent Document 1: JP4238510B

Patent Document 2: JP4284780B

### SUMMARY OF THE INVENTION

### Task to be Accomplished by the Invention

However, in the sound insulation structure disclosed in Patent Document 1, since the shape of the sound insulation member is complicated, it is difficult to mold the sound insulation member, and installing and removing the sound insulation member cannot be performed in an efficient manner

In the sound insulation structure disclosed in Patent Document 2, although the work efficiency in installing and removing the sound insulation member is improved, the sound insulation cover does not completely enclose noise sources such as fuel injectors that generate fuel injection noises and a fuel pipe system that transmits vibrations from other parts of the engine. Therefore, the noise emitted from the noise sources inevitably leaks to the outside through a gap created between the sound insulation cover and the engine.

With the aim of completely shutting off the emission of noises to the outside, it is therefore conceivable to install the sound insulation cover in such a manner that the outer periphery of the sound insulation cover abuts the engine so as to interpose the noise sources, and the noise sources are thereby contained inside the outer periphery of the sound insulation cover. However, in order to allow the sound insulation cover to be installed and removed without any undue difficulty, it is necessary to create a clearance between the sound insulation cover and the engine. It is also possible that such a clearance may be created unintentionally. In either case, the noises are leaked to the outside through these clearances.

The present invention was made in view of such a problem of the prior art, and has a primary object to provide a sound insulation structure for an internal combustion engine that simplifies the assembly work, and is able to effectively reduce the leakage of vibrations and noises.

### Means to Accomplish the Task

To achieve such an object, the present invention provides a sound insulation structure for an internal combustion engine (1), comprising: a cover main body (21) disposed outside of a main body (10) of the internal combustion engine and covering at least a part of the engine main body; and a foam sound insulation member (22) made of a foam material and attached to a surface (21a) of the cover main body facing the engine main body; wherein the foam sound insulation member covers a noise source (11) of the engine main body and abuts the engine main body or a component part (12, 14) attached to the engine main body at an outer periphery thereof so as to interpose the noise source; and wherein the engine main body (10) or the component part (14) includes a sound insulation wall (31-33) projecting therefrom so as to shield a junction part at which the foam sound insulation member abuts or adjoins the engine main body or the component part thereof and the sound insulation wall is covered by the cover main body.

According to this configuration, since the foam sound insulation member covers the noise source (11) of the engine main body and abuts the engine main body or the component part attached to the engine main body at the outer periphery thereof so as to interpose the noise source, the noise source is completely surrounded by the foam sound insulation member so that the leakage of vibrations and noises can be minimized Furthermore, the assembly work is simplified because the assembly work simply consists of attaching the cover main body and the foam sound insulation member to the engine main body so as to cover the noise source. Also, since the sound insulation wall projecting from the engine main body or the component part so as to be covered by the cover main body shields the junction part between the foam sound insulation member and the engine main body or the component part, even when a clearance or a gap is created in the junction part, the leakage of noises can be minimized

In this invention, it may be arranged such that the engine main body includes a cylinder block (3) defining a cylinder (2), a cylinder head (4) attached to an end face of the cylinder block, a cylinder head cover (5) attached to a face of the cylinder head remote from the cylinder block, and a fuel injection device (11) passed through the cylinder head cover and attached to the cylinder head, wherein the foam sound insulation member covers the fuel injection device from outside, and the sound insulation wall (31, 32) is positioned so as to shield the junction part from outside.

According to this arrangement, since the sound insulation wall is provided at a position to shield the junction part between the foam sound insulation member covering the fuel injection device (the noise source) and the engine main body from outside, the energy of the sound leaking from the junction part is absorbed by the sound insulation wall, and the sound that has leaked is also reflected by the sound insulation wall to be impinged upon the foam sound insulation member again. Thereby, a sound absorbing effect and a sound attenuating effect are obtained so that a high level of quietness can be achieved.

In this invention, it is preferable that an outer periphery of the cover main body adjoins the engine main body or the component part so as to be shielded by the sound insulation wall from inside so that the sound insulation wall (31, 32) forms a labyrinth structure in cooperation with the outer periphery of the foam sound insulation member and the outer periphery of the cover main body.

According to this configuration, the sound that has passed through the sound insulation wall is reflected by the outer periphery of the cover main body and is thereby prevented from leaking to the outside of the cover main body. As a result, the sound absorbing effect and the sound attenuating effect are further enhanced.

To achieve such an object, the present invention further provides a sound insulation structure for an internal combustion engine (1), comprising: a main body (10) of the internal combustion engine equipped with a plurality of fuel injection devices (11) arranged along a cylinder row direction and exposed on an outer surface of the engine main body; a wire harness holder (14) extending along the cylinder row direction on an outer side of the engine main body and internally accommodating a wire harness connected to the fuel injection devices; a fuel supply unit (12) arranged along the cylinder row direction on a side of the fuel injection devices facing away from the wire harness holder and configured to supply fuel to the fuel injection devices via respective fuel pipes (13); a cover main body (21) disposed on a more outer side of the engine main body than the wire harness holder and the fuel supply unit; and a foam sound insulation member (22) made of a foam material and attached to a surface (21a) of the cover main body facing the engine main body to cover at least a part of the fuel injection devices and the wire harness holder; wherein a first side (22c) of the foam sound insulation member extending along the cylinder row direction abuts the engine main body, and a second side (22d) of the foam sound insulation member extending along the cylinder row direction abuts the fuel supply unit; and wherein an end (22e) of the foam sound insulation member extending orthogonally to the cylinder row direction abuts or adjoins an outer surface of the wire harness holder, and a sound insulation wall (32) projects from a part of the wire harness holder covered by the cover main body so as to shield a junction part at which the foam sound insulation member abuts or adjoins the wire harness holder.

In order to reduce the vibrations and noises from the fuel injection devices, it is effective to surround the fuel injection devices with a sound insulation member from four sides. However, because the fuel injection devices are electric components that are required to be connected to a wire harness, it is difficulty to completely surround the fuel injection devices with a sound insulation member. The wire harness holder has a relatively low stiffness as compared to the engine main body and the fuel supply unit. Therefore, it is not practical to abut the foam sound insulation member onto the wire harness holder in a strongly compressed state owing to an excessive deformation of the wire harness holder. Therefore, sound may leak out from a gap that is created in the junction part. Therefore, by abutting the side edges of the foam sound insulation member extending along the cylinder row direction onto the engine main body and the fuel supply unit, respectively, and shielding the junction part at which the foam sound insulation member abuts or adjoins the wire harness holder with the sound insulation wall projecting from the wire harness holder, the leakage of sound from the junction part can be minimized

In this invention, the sound insulation wall (32) may be positioned so as to shield the junction part from outside.

According to this configuration, the sound that has leaked from the junction part is deprived of energy by the sound insulation wall and reflected by the sound insulation wall to be impinged upon the sound insulation member once again. Thereby, a sound absorbing effect and a sound attenuating effect are obtained, and a high level of quietness can be achieved.

To achieve such an object, the present invention further provides a sound insulation structure for an internal combustion engine (1), comprising: a cover main body (41) arranged outside of a main body (10) of the internal combustion engine and covering at least a part of the engine main body; and a foam sound insulation member (22) made of a foam material and attached to a surface (21a) of the cover main body facing the engine main body; wherein the surface of the cover main body facing the engine main body is formed with a plurality of engagement projections (23) each having an engagement claw (23b) at a free end thereof, and the foam sound insulation member is retained by the engagement projections so that at least an end part (22c, 22d) of the foam sound insulation member abuts the engine main body or a component part (12) attached to the engine main body; wherein the engagement projections provided adjacent to the end part of the foam sound insulation member project in a direction orthogonal to a surface of a part of the cover main body adjoining the engagement projections, the projecting direction of the engagement projections provided adjacent to the end part of the foam sound insulation member being different from those of the remaining engagement projections.

According to this configuration, it is possible to bring the engagement projection close to the one end part of the foam sound insulation member while reliably retaining the foam sound insulation member onto the surface of the cover main body so that the one end part of the foam sound insulation member is prevented from being peeled off from the cover main body. Because the engagement projections adjoining the one end part of the foam sound insulation member projects in a different direction from the remaining engagement projections so that the foam sound insulation member is prevented from being detached from the engagement projections even under external forces such as the gravitational force and vibrations. Because the attachment of the foam sound insulation member can be carried out by engaging the foam sound insulation member with the engagement projections one after another, the assembly work is facilitated.

### Effect of the Invention

Thus, according to the present invention, the assembly work for a sound insulation structure for an internal combustion engine can be facilitated, and the leakage of vibrations and noises can be effectively reduced.

### BRIEF DESCRIPTION OF THE DRAWINGS

FIG. 1 is a schematic perspective view of an internal combustion engine to which a sound insulation structure according to an embodiment of the present invention is applied;

FIG. 2 is a sectional view taken along a vertical plane extending in the fore and aft direction of the vehicle and showing an upper part of the engine shown in FIG. 1;

FIG. 3 is a plan view of an engine cover;

FIG. 4a is a perspective view showing an engagement projection shown in FIG. 3;

FIG. 4b is a perspective view showing a slit formed in the foam sound insulation member shown in FIG. 3;

FIG. 5 is a sectional view taken along a vertical plane extending in the fore and aft direction different from that of FIG. 1 and showing a part of the engine;

FIG. 6 is a sectional view taken along line VI-VI of FIG. 3;

FIG. 7 is a sectional view taken along line VII-VII of FIG. 3; and

FIG. 8 is a sectional view taken along line VIII-VIII of FIG. 3.

### DETAILED DESCRIPTION OF THE PREFERRED EMBODIMENT(S)

An embodiment of the present invention will be described in detail with reference to the appended drawings. In the following description, “front and rear” and “up and down” indicated by arrows in each drawing indicate the fore and aft direction and the vertical direction of the vehicle body, respectively, and “left and right” indicate the left and right directions with respect to the view from the driver's seat.

An internal combustion engine 1 to which a sound insulation structure according to an embodiment of the present invention is applied, for example, consists of a multi-cylinder, direct injection diesel engine, which is positioned laterally in the engine room and is inclined rearward. Incidentally, the internal combustion engine 1 is not limited to a diesel engine, but may also be a direct injection gasoline engine or the like, for example

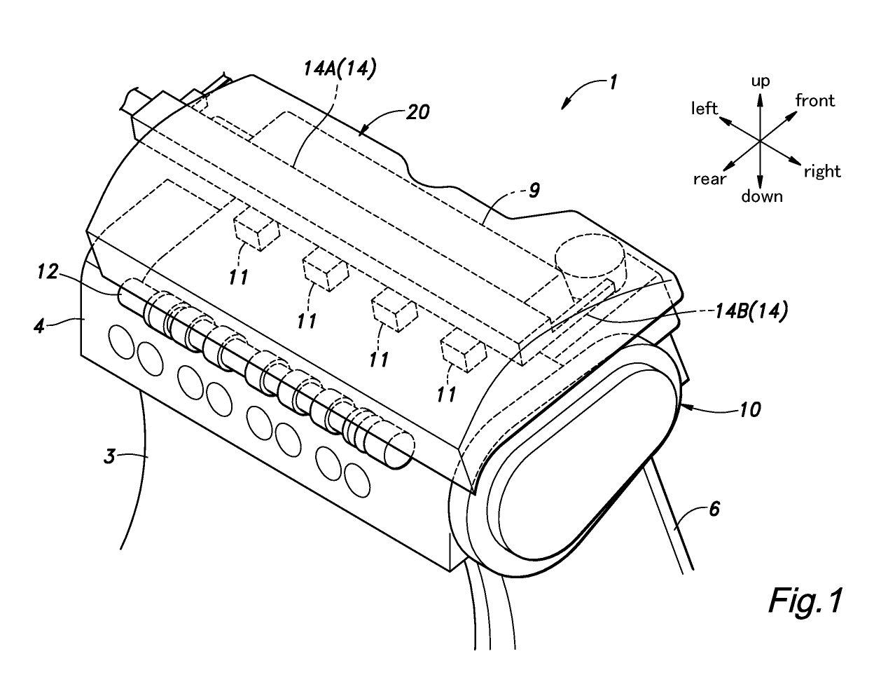

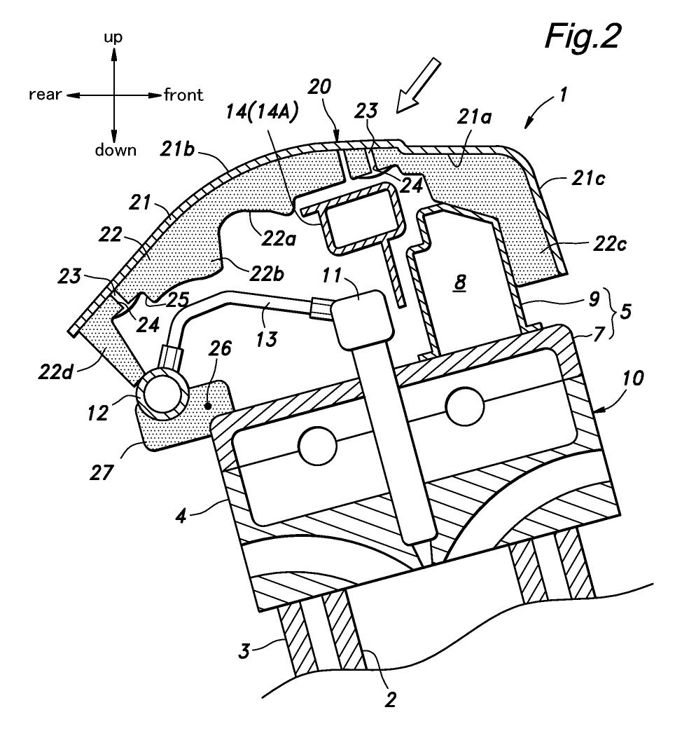

As shown in FIGS. 1 and 2, the internal combustion engine 1 includes a cylinder block 3 defining a plurality of cylinders 2 (see FIG. 2) arranged in series in the lateral direction, a cylinder head 4 coupled to the top surface of the cylinder block 3, a cylinder head cover 5 (FIG. 2) coupled to the upper surface of the cylinder head 4, and a chain cover 6 coupled to an end wall jointly formed by the cylinder block 3, the cylinder head 4, and the cylinder head cover 5.

The cylinder head cover 5 includes a head cover lower part 7 for closing the upper opening of the cylinder head 4, a breather chamber 9 (head cover upper part) which is attached to the upper surface of the head cover lower part 7 and defines a gas/liquid separation chamber 8 in cooperation with the head cover lower part 7. The breather chamber 9 is a rectangular hollow member elongated in the lateral direction, and protrudes upward at the front part of the head cover lower part 7. In the present embodiment, the breather chamber 9 and the head cover lower part 7 are formed separately from each other, but the present invention is not limited thereto, and the breather chamber 9 and the head cover lower part 7 may also be integrally formed to each other.

The cylinder block 3, the cylinder head 4, the cylinder head cover 5, the chain cover 6, etc. jointly form the engine main body 10.

A plurality of fuel injectors (high-pressure fuel injection devices) 11 for injecting the high pressure fuel into the respective cylinders 2 are mounted along the lateral direction at an approximately central part of the cylinder head 4 with respect to the fore an aft direction. These fuel injectors 11 are attached to the cylinder head 4 so as to protrude upward through the cylinder head cover 5, and are exposed on the outer surface of the engine main body 10.

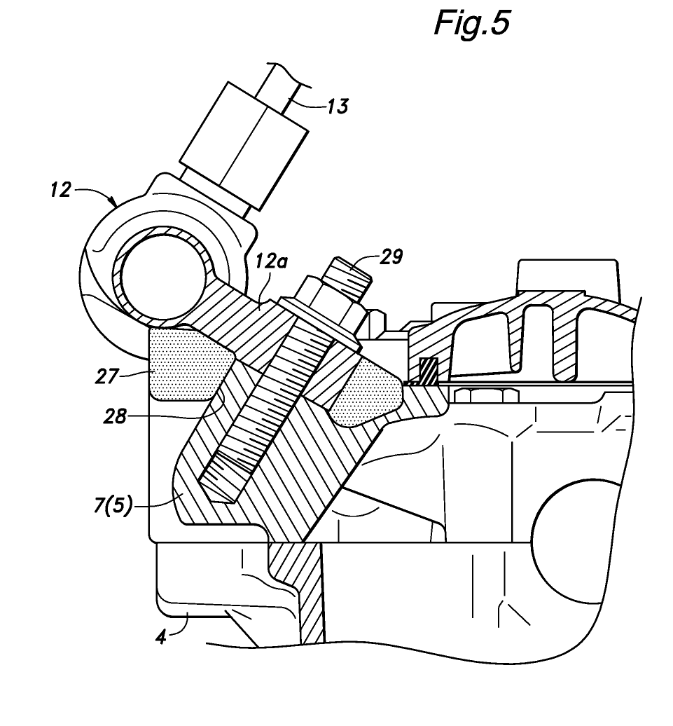

A single common rail (fuel supply unit) 12 for supplying the high pressure fuel to the fuel injectors 11 is disposed behind the fuel injectors 11 or on the side thereof remote from the breather chamber 9. The common rail 12 is made of a substantially cylindrical metallic member extending along the lateral direction, or along the row of the fuel injectors 11, and is fixedly secured to the head cover lower part 7 via two attachment portions 12a (see FIG. 5) formed integrally with the common rail 12. The common rail 12 is connected to the fuel injectors 11 via respective fuel pipes 13. Thus, the common rail 12 is an engine component part mounted on the engine main body 10.

A wire harness holder 14 that accommodates a wire harness for supplying electric power to the fuel injectors 11 is disposed above the fuel injectors 11 and slightly offset to the side of the breather chamber 9. The wire harness holder 14 is made of a plastic tube having a rectangular cross section and extending in the lateral direction or along the row of the fuel injectors 11, and is fixedly attached to the engine main body 10 by fixing means (not shown the drawings). Thus, the wire harness holder 14 is also an engine component part mounted on the engine main body 10. The wire harness housed in the wire harness holder 14 extends from the wire harness holder 14 at positions corresponding to the respective fuel injectors 11 and is connected to the respective fuel injectors 11.

An engine cover 20 that covers a part of the upper surface of the engine main body 10 is disposed above the engine main body 10. The engine cover 20 is detachably attached to the engine main body 10 by fastening means such as threaded bolts and clips (not shown in the drawings), and the fuel injectors 11, the common rail 12, the fuel pipes 13, the wire harness holder 14, etc. are received in the space defined between the engine cover 20 and the engine main body 10.

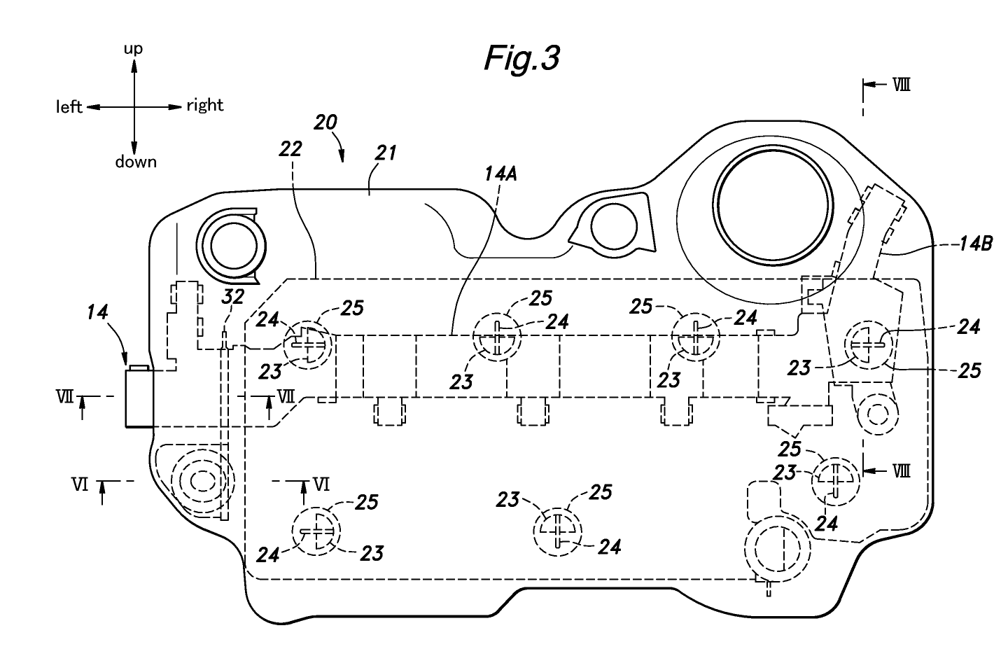

As shown in FIG. 3, the engine cover 20 has a substantially rectangular shape in plan view. As shown in FIGS. 2 and 3, the engine cover 20 is made of a plastic member disposed above the engine main body 10, and includes a cover main body 21 covering at least a part of the engine main body 10, and a foam sound insulation member 22 made of an elastic foam material and attached to the inner surface 21a of the cover main body 21 facing the engine main body 10. The foam sound insulation member 22 has a smaller profile than the cover main body 21 in plan view, and has a substantially rectangular shape similarly as the cover main body 21.

In order to supply electric power to the fuel injector 11 provided on the top face of the engine main body 10 from a source external to the engine main body 10, the wire harness holder 14 includes a left end part which is external to the engine cover 20 and a holder main body 14A extending inside the engine cover 20 in plan view. The wire harness holder 14 is additionally provided with an extension 14B that extends forward from a part of the holder main body 14A adjoining the right end of the engine cover 20. The holder main body 14A does not extend beyond the outer profile of the cover main body 21, but extends beyond the outer profile of the foam sound insulation member 22.

A plurality of engagement projections 23 are integrally provided on the inner surface 21a of the cover main body 21. The engagement projections 23 are arranged generally in two rows on the front side and the rear side of the cover main body 21. A slit 24 is formed at a position of the foam sound insulation member 22 corresponding to each engagement projection 23. The foam sound insulation member 22 is fixed to the cover main body 21 by inserting the engagement projections 23 into the corresponding slits 24.

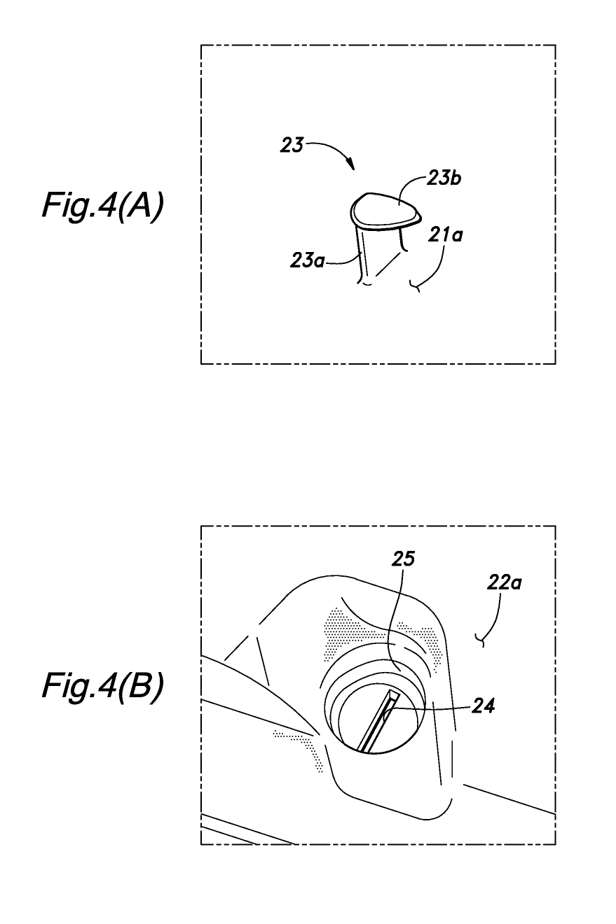

As shown in FIG. 4a, each engagement projection 23 of the cover main body 21 includes a shaft portion 23a protruding away from the inner surface 21a of the cover main body 21, and an engagement claw 23b consisting of a semicircular plate formed at the free end of the shaft portion 23a and having a major plane extending orthogonally to the axial line of the shaft portion 23a.

As shown in FIG. 4b, each slit 24 of the foam sound insulation member 22 has a linear shape extending in a direction orthogonal to the chord of the semicircular shape of the engagement claw 23b (see FIG. 3), and has a depth corresponding to the protruding length of the shaft portion 23a of each engagement projection 23. The foam sound insulation member 22 has a greater thickness than the protruding length of the shaft portions 23a of the engagement projections 23 as a whole. Therefore, the inner surface 22a of the foam sound insulation member 22 facing away from the cover main body 21 is formed with substantially circular recesses in the parts thereof corresponding to the respective slits 24.

The engagement projections 23 provided in the cover main body 21 are each forced into the corresponding slit 24 and the engagement claw 23b is caused to engage the inner surface 22a of the foam sound insulation member 22 after passing through the corresponding slit 24 whereby the foam sound insulation member 22 is integrally attached to the cover main body 21 so as to make a surface contact with the inner surface 21a of the cover main body 21 (see FIG. 2).

As shown in FIG. 2, the cover main body 21 includes a main plate portion 21b having a curved cross sectional shape such that the central part thereof with respect to the fore and aft direction projects upward, and a front wall portion 21c depending continuously from the front edge of main plate portion 21b. The cover main body 21 (main plate portion 21b) covers the fuel injectors 11 from above in a spaced apart relationship. The front wall portion 21c covers an upper front portion (the breather chamber 9) of the engine main body 10 from the front.

In addition to the main plate portion 22b corresponding to the outer profile of the cover main body 21 and the front wall portion 22c mentioned above, the foam sound insulation member 22 has a rear wall portion 22d that continuously depends from the rear edge of the main plate portion 22b. The cover main body 21 opposes the outer side of the main plate portion 22b and the front wall portion 22c, but does not include a part that opposes the outer side of the rear wall portion 22d.

The main plate portion 22b of the foam sound insulation member 22 is in contact with the upper surface of the breather chamber 9, but is not in contact with the wire harness holder 14. The front wall portion 22c of the foam sound insulation member 22 is in contact with the upper face and the front face of the breather chamber 9. The rear wall portion 22d of the foam sound insulation member 22 is configured in such a manner that the projecting end surface thereof abuts the upper side of the common rail 12. While the foam sound insulation member 22 is in this attached condition, the engine cover 20 (consisting of the cover main body 21 and the foam sound insulation member 22 attached to the cover main body 21), which is attached to the engine main body 10 by the fastening means, extends from a position located directly above a front part of the engine main body 10 to a part depending toward a rear part of the engine main body 10 as indicated by a white arrow in FIG. 2.

The wall portion 22d of the foam sound insulation member 22 could interfere with the common rail 12, the fuel pipes 13, etc., with the result that the rear end of the main plate portion 22b of the foam sound insulation member 22 could be curled up away from the cover main body 21. To prevent this from occurring, the engagement projections 23 arranged in the rear row are positioned adjacent to the rear end of the cover main body 21.

The assembly work for attaching the foam sound insulation member 22 to the cover main body 21 would be easy if all of the engagement projections 23 (the shaft portion 23a) projected in a same direction. However, in the case where the main plate portion 21b of the cover main body 21 is curved as described above, if the engagement projections 23 of the front row and the back row are both oriented in a same direction, the engagement projections 23 arranged in the front row will be tilted rearward with respect to the adjoining part of the inner surface 21a (more precisely, with respect to the tangential plane of a part of the inner surface 21a from which the engagement projection 23 projects), and the engagement projections 23 arranged in the rear row will be tilted forward with respect to the adjoining part of the inner surface 21a.

In such a case, if a predetermined minimum thickness is given to the foam sound insulation member 22 at the position corresponding to each engagement claw 23b, the protruding length of the shaft portion 23a of the corresponding engagement projection 23 becomes long to such an extent that the shaft portion 23a may flex, allowing the foam sound insulation member 22 to be lifted from the cover main body 21. Therefore, in the present embodiment, the shaft portions 23a of the engagement projections 23 arranged in the rear row project in a direction orthogonal to the inner surface 21a of the main plate portion 21b of the cover main body 21. In other words, the engagement projections 23 provided in the vicinity of the rear end of the foam sound insulation member 22 project in a direction different from the engagement projections 23 provided in the front row.

Thus, by arranging the engagement projections 23 of the rear row in the vicinity of the rear end of the cover main body 21 and reducing the projecting length of the shaft portions 23a of the engagement projections 23 of the rear row, the rear end portion of the foam sound insulation member 22 is prevented from separating from the cover main body 21 by peeling off, and the foam sound insulation member 22 is securely held on the inner surface 21a of the cover main body 21. Also, since the engagement projections 23 provided in the vicinity of the rear end of the foam sound insulation member 22 project in a direction different from the engagement projections 23 of the front row, the foam sound insulation member 22 is prevented from being detached from the engagement projections 23 owing to the gravitational force and vibrations. Also, the assembly work in attaching the foam sound insulation member 22 to the cover main body 21 is facilitated because the foam sound insulation member 22 can be engaged first by the engagement projections 23 of the front rows and then the engagement projections 23 of the rear rows.

A gap 26 is created between the lower side of the common rail 12 and the cylinder head cover 5. A spacer 27 formed separately from the cover main body 21 and the foam sound insulation member 22 is positioned in this gap 26. The spacer 27 is formed as a single piece member made of the same foam material as the foam sound insulation member 22, and extends substantially in parallel with the central axis of the common rail 12. In the present embodiment, the spacer 27 is formed of the same foam material as the foam sound insulation member 22, but it may be formed of a foam material different from the foam sound insulation member 22 as long as the sound insulation performance and durability are comparable.

As shown in FIG. 5, the spacer 27 is formed with two through holes 28 extending substantially in the vertical direction, and threaded bolts (fastening members) 29 are passed through the through hole 28 to fixedly secure the common rail 12 to the upper surface of the cylinder head cover 5 via the mounting portions 12a so that the spacer 27 and the common rail 12 can be attached to the cylinder head cover 5 at the same time. The spacer 27 attached to the cylinder head cover 5 is interposed between the cylinder head cover 5 and the common rail 12, and fills the gap 26 formed between them.

In addition to the through hole 28, a slit-like incision extending from a side surface of the spacer 27 to the through hole 28 may be formed in the spacer 27. In this case, the spacer 27 may be fitted into the gap 26 between the common rail 12 and the cylinder head cover 5 by pressing the spacer 27 in the lateral direction so that the mounting portion 12a and the bolt 29 are pushed into the through hole 28 along the incision.

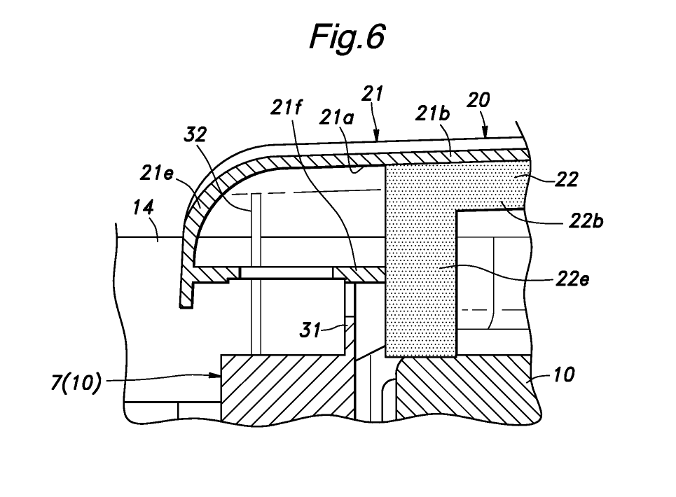

The structure of a junction part (where the foam sound insulation member 22 abuts or adjoins the engine main body 10) between the engine cover 20 and the engine main body 10 is described in the following with reference to FIGS. 6 to 8.

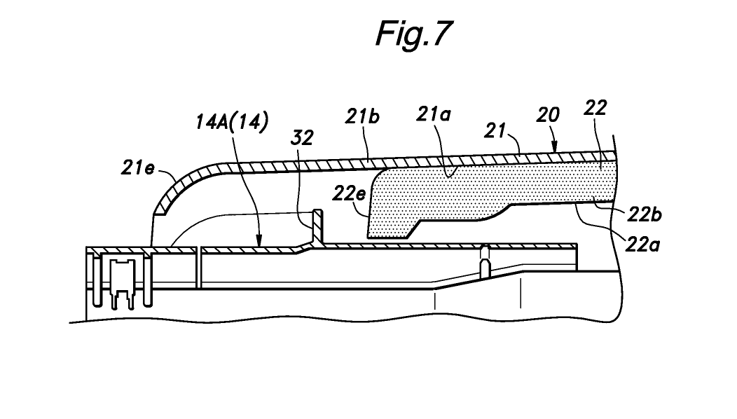

FIG. 6 shows a cross section of a left end part of the engine cover 20 where the wire harness holder 14 is absent, and FIG. 7 shows a cross section of a left end part of the engine cover 20 where the wire harness holder 14 is present. As shown in FIG. 6, the foam sound insulation member 22 is provided with a left wall portion 22e that continuously depends from the left edge of the main plate portion 22b. Meanwhile, the cover main body 21 is provided with a left wall portion 21e that continuously depends from the left edge of the main plate portion 21b, and a left position restricting portion 21f that restricts the leftward movement of the foam sound insulation member 22. The left wall portion 21e of the cover main body 21 is configured so that the lower end thereof does not contact the engine main body 10. On the other hand, the left wall portion 22e of the foam sound insulation member 22 is configured so that its lower end abuts the upper surface of the engine main body 10.

In the part where the wire harness holder 14 is absent as shown in FIG. 6, a first sound insulation wall 31 integrally formed with the engine main body 10 projects upright from a part of the upper surface of the engine main body 10 which is more outward (leftward) that the foam sound insulation member 22 (a left wall portion 22e thereof) and more inward (more rightward than the outer periphery) than the cover main body 21 (a left wall 21e portion thereof) so as to shield the abutting part (junction part) between the foam sound insulation member 22 and the engine main body 10 from outside. The first sound insulation wall 31 is configured such that the upper end thereof adjoins the lower surface of the cover main body 21 without contacting the cover main body 21. The left wall portion 21e forming the outer periphery of the cover main body 21 depends downward to a position adjoining the engine main body 10 so as to be shielded by the first sound insulation wall 31 from inside. In other words, the first sound insulation wall 31 forms a labyrinth structure in cooperation with the left wall portion 22e forming the outer periphery of the foam sound insulation member 22 and the left wall portion 21e of the cover main body 21.

Although not shown in the drawings, even in a left end part of the engine cover 20 where the breather chamber 9 is present, the first sound insulation wall 31 projects upward from the breather chamber 9 which forms a part of the engine main body 10 so as to shield the junction part between the foam sound insulation member 22 and the breather chamber 9 from outside.

In a position where the wire harness holder 14 is provided as shown in FIG. 7, the left wall portion 21e of the cover main body 21 is provided in such a manner that the lower end of the left wall portion 21e adjoins the upper surface of the wire harness holder 14 without contacting the wire harness holder 14. Meanwhile, the left wall portion 22e of the foam sound insulation member 22 is provided in such a manner that the lower end of the left wall portion 22e adjoins the upper surface of the wire harness holder 14 without contacting the wire harness holder 14. This is advantageous because the wire harness holder 14 has a low rigidity as compared to the engine main body 10 and the common rail 12, and the wire harness holder 14 (the main body 14A) is prone to deformation if the foam sound insulation member 22 is brought into contact with the wire harness holder 14 in a compressed state.

Even in a part where the wire harness holder 14 is provided, the lower end of the left wall portion 22e of the foam sound insulation member 22 may be in contact with the engine main body 10. In this case, it is preferable to set the compression stroke of the left wall portion 22e of the foam sound insulation member 22 to be comparatively smaller and to reduce the pressure applied to the wire harness holder 14 (the main body 14A) than the pressure applied to the remaining part of the engine main body 10.

In a part of the wire harness holder 14 on the outside of the foam sound insulation member 22 (the left wall portion 22e) and inside the cover main body 21 (the left wall portion 21e), a second sound insulation wall 32 integrally projects from the wire harness holder 14 so as to shield a part (junction part) where the foam sound insulation member 22 and the engine main body 10 adjoin each other from outside Similarly to the first sound insulation wall 31 formed on the engine main body 10, the second sound insulation wall 32 is provided in such a manner that the upper end thereof adjoins the lower face of the cover main body 21 without contacting the cover main body 21. On the other hand, the second sound insulation wall 32 projects not only from the upper face of the wire harness holder 14 but also from the both side surfaces (the front surface and rear surface) of the wire harness holder 14 (see FIGS. 3 and 6) so that the second sound insulation wall 32 is provided with a continuous U shape. The left wall portion 21e of the cover main body 21 adjoins the engine main body 10 while being shield by the second sound insulation wall 32 from inside so that the second sound insulation wall 32 forms a labyrinth structure in cooperation with the left wall portion 22e of the foam sound insulation member 22 and the left wall portion 21e of the cover main body 21, similarly as in FIG. 6.

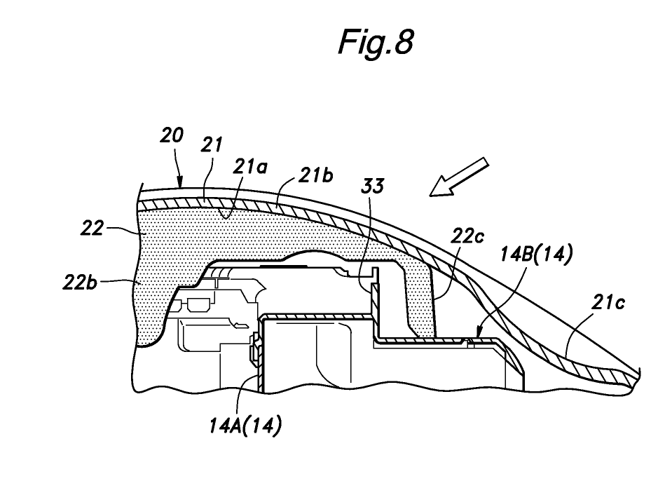

FIG. 8 shows a cross section of a front end part of the right side of the engine cover 20 where the extension 14B of the wire harness holder 14 is present. As discussed above, the cover main body 21 is provided with the front wall portion 21c which is continuous with the front edge of the main plate portion 21b, and the foam sound insulation member 22 is provided with the front wall portion 22c which is continuous with the front edge of the main plate portion 22b. The front wall portion 21c of the cover main body 21 is provided in such a manner that the lower end thereof adjoins the upper surface of the engine main body 10 without contacting the engine main body 10. On the other hand, the front wall portion 22c of the foam sound insulation member 22 is provided in such a manner that the lower end thereof abuts or contacts the upper surface of the engine main body 10. This creates no problem because the extension 14B of the wire harness holder 14 has a small cross section and a relatively high stiffness, and the front wall portion 22c of the foam sound insulation member 22 extends by a relatively large length and has a relatively small thickness, the extension 14B of the wire harness holder 14 is resistant to deformation even when the front wall portion 22c of the foam sound insulation member 22 is brought into contact with the extension 14B of the wire harness holder 14 in a compressed state.

In a part of the wire harness holder 14 inside the cover main body 21 (the front wall portion 21c) and outside of the foam sound insulation member 22 (the front wall portion 22c), a third sound insulation wall 33 integrally projects from the upper surface and the two side surfaces of the wire harness holder 14 so as to shield a part where the foam sound insulation member 22 abuts the wire harness holder 14 from inside. The third sound insulation wall 33 shields the abutting part from inside because the engine cover 20 is disposed above the engine main body 10 and extends from the upper front side to the lower rear side as indicated by the white arrow shown in FIG. 8. The third sound insulation wall 33 is provided in such a manner that the upper end thereof adjoins the lower surface of the foam sound insulation member 22 without contacting the foam sound insulation member 22.

The internal combustion engine 1 to which the sound insulation structure according to the present embodiment is applied is configured as described above. The function and effect of this embodiment will be described in the following.

In each fuel injector 11, a plunger is moved between a valve opening position and a valve closing position at high speed by a solenoid and a spring member incorporated in the fuel injector 11 in order to inject the high pressure fuel for a prescribed time period at a prescribed timing. Since the fuel injector 11 emits an impact sound owing to this action, the fuel injector 11 is a source of noises and vibrations of a relatively high intensity among other components of the engine 1. In addition, the common rail 12 connected to the fuel injectors 11 via the respective fuel pipes 13 transmits noises, and becomes a source of noises.

In the present embodiment, as shown in FIG. 2, the foam sound insulation member 22 attached to the cover main body 21 covers the fuel injector 11 and the common rail 12, which are major sources of vibrations and noises among the various component parts of the engine1, from above so that the emission of noises can be minimized. Because the gap between the common rail 12 and the cylinder head cover 5 is closed by the spacer 27, the common rail 12 is fully enclosed. As a result, the leakage of sound into the cabin and to the outside can be minimized

In the present embodiment, the foam sound insulation member 22 attached to the inner surface 21a of the cover main body 21 facing the engine main body 10 covers the fuel injectors 11, which are sources of noises, and abuts the engine main body 10 and the engine component parts such as the common rail 12 and the wire harness holder 14 along the front side and the rear side of the engine main body 10 at the outer periphery of the foam sound insulation member 22 so as to interpose the fuel injectors 11. As shown in FIGS. 6 to 8, the engine main body 10 and the wire harness holder 14 are formed with the first to third sound insulation walls 31 to 33 at positions covered by the cover main body 21 so as to shield the abutting portion or the adjoining portion at which the foam sound insulation member 22 abuts or adjoins the engine main body 10 and the wire harness holder 14, respectively.

Thus, because the foam sound insulation member 22 is arranged such that the outer periphery thereof is brought into contact with the engine main body 10 or the wire harness holder 14 so as to interpose the fuel injectors 11, the fuel injectors 11 are enclosed by the foam sound insulation member 22, and the leakage of vibrations and noises is minimized In addition, since the cover main body 21 and the foam sound insulation member 22 are simply attached to the engine main body 10 so as to cover the fuel injectors 11, the assembling work thereof is simplified. Since the junction part between the engine main body 10 or the wire harness holder 14 and the foam sound insulation member 22 is shielded by the first to third sound insulation walls 31 to 33 projecting upright from the part covered by the cover main body 21, the leakage of noises from the gap that may be created in the junction part is minimized.

As shown in FIG. 2, the engine main body 10 includes the cylinder block 3 defining the cylinders 2, the cylinder head 4 attached to the upper surface of the cylinder block 3, the cylinder head cover 5 attached to the upper surface of the cylinder head 4 facing away from the cylinder block 3, and the fuel injectors 11 passed through the cylinder head cover 5 and attached to the cylinder head 4, and the foam sound insulation member 22 covers the fuel injectors 11 from above. As shown in FIGS. 6 and 7, the first and second sound insulation walls 31 and 32 are provided on the outside of the junction part between the foam sound insulation member 22 and the engine main body 10 or the wire harness holder 14.

Thus, the first and second sound insulation walls 31 and 32 are positioned so as to shield the junction part between the foam sound insulation member 22 covering the fuel injectors 11 and the engine main body 10 or the wire harness holder 14 from outside. Therefore, the sound leaking from the junction part is deprived of energy by the first and second sound insulation walls 31 and 32, and is reflected by the first and second sound insulation walls 31 and 32 to impinge upon the foam sound insulation member 22 once again. As a result, a sound absorbing effect and sound attenuating effect can be obtained, and a high level of quietness can be achieved.

The left wall portion 21e forming the outer periphery of the cover main body 21 adjoins the engine main body 10 or the wire harness holder 14 so as to be shielded by the first and second sound insulation walls 31 and 32 from inside so that the sound insulation walls 31 and 32 form a labyrinth structure in cooperation with the left wall portion 22e forming the outer periphery of the foam sound insulation member 22 and the left wall portion 21e of the cover main body 21. Therefore, the sound that has passed through the first and second sound insulation walls 31 and 32 is reflected by the left wall portion 21e of the cover main body 21, and is thereby prevented from leaking to the outside of the cover main body 21. As a result, the sound absorbing effect and sound attenuating effect are further enhanced.

In reducing vibrations and noises from the fuel injectors 11, it is effective to enclose the fuel injector 11 from four sides with the foam sound insulation member 22. However, because the fuel injectors 11 are electric components that are required to be connected to the wire harness, it is difficulty to completely surround the fuel injectors 11 with the foam sound insulation member 22, and the configuration of the foam sound insulation member 22 will be required to be highly complex. Further, as opposed to the engine main body 10 such as the cylinder head cover 5 and the common rail 12 attached to the engine main body 10, the wire harness holder 14 has such a low stiffness that it is not practical to place the foam sound insulation member 22 in a compressed state in bringing the foam sound insulation member 22 into contact with the wire harness holder 14. Therefore, sound leakage from the gap in the junction part is inevitable.

In the illustrated embodiment, as shown in FIG. 2, the front wall portion 22c of the foam sound insulation member 22 extending along the cylinder row direction abuts the breather chamber 9 forming a part of the engine main body 10, and the rear wall portion 22d of the foam sound insulation member 22 extending along the cylinder row direction abuts the common rail 12. As shown in FIG. 7, the left wall portion 22e of the foam sound insulation member 22 extending in the direction orthogonal to the cylinder row direction adjoins the outer surface of the wire harness holder 14, and the second sound insulation wall 32 projects upward from a part of the wire harness holder 14 covered by the cover main body 21 so as to shield the junction part between the foam sound insulation member 22 and the wire harness holder 14.

Thus, the front and rear ends of the foam sound insulation member 22 each extending along the cylinder row direction abut the engine main body 10 or the common rail 12, and the second sound insulation wall 32 is provided on the wire harness holder 14 so as to shield the part where the wire harness holder 14 and the foam sound insulation member 22 adjoin each other. Thereby, the sound leakage from the junction part is minimized

In particular, since the second sound insulation wall 32 is disposed so as to shield the junction part from outside, the sound leaking from the junction part is deprived of its energy by the second sound insulation wall 32, and is reflected by the second sound insulation wall 32 to impinge upon the foam sound insulation member 22 once again. As a result, a sound absorbing effect and a sound attenuating effect can be obtained, and a high level of quietness can be achieved.

In the present embodiment, as shown in FIG. 4, the engagement projections 23 each having the engagement claw 23b at the tip are formed on the inner surface 21a of the cover main body 21 facing the engine main body 10. As shown in FIG. 3, the foam sound insulation member 22 is retained to the engine main body 10 such that the rear wall portion 22d and the front wall portion 22c are in contact with the engine main body 10 and the common rail 12, respectively, by using the engagement projections 23. Further, as shown in FIG. 2, the engagement projections 23 of the rear row provided in the vicinity of the rear wall portion 22d of the foam sound insulation member 22 project in the direction which is different from the direction in which the engagement projections 23 of the front row provided in the other positions project, and which is orthogonal to the tangential plane of the part of the cover main body 21 in which the engagement projections 23 of the rear row are provided.

Therefore, it is possible to reliably retain the foam sound insulation member 22 on the inner surface 21a of the cover main body 21, and to bring the engagement projections 23 of the rear row close to the rear end of the foam sound insulation member 22 so that the rear end of the foam sound insulation member 22 is prevented from separating from the cover main body 21 by peeling off from the inner surface 21a of the cover main body 21. In addition, because the rear row engagement projections 23 provided in the vicinity of the rear wall portion 22d of the foam sound insulation member 22 protrude in the different direction from the engagement projections 23 of the front row, the foam sound insulation member 22 is prevented from being detached from the engagement projection 23 by external forces such as the gravitational force and vibrations. Because the attachment of the foam sound insulation member 22 can be carried out by engaging the foam sound insulation member 22 with the engagement projections 23 one after another, the assembly work is facilitated.

Although the present invention has been described in terms of a preferred embodiment thereof, it is obvious to a person skilled in the art that various alterations and modifications are possible without departing from the scope of the present invention. For example, various changes may be made to the specific configuration, arrangement, quantity, angle, material, etc. of each member/part without departing from the spirit of the present invention. The various components used in the illustrated embodiments are not entirely essential to the present invention, but may be omitted and substituted as required.

### GLOSSARY OF TERMS

1 internal combustion engine
2 cylinder
3 cylinder block
4 cylinder head
5 cylinder head cover
6 chain cover
7 head cover lower part
8 gas/liquid separation chamber
9 breather chamber (head cover upper part)
10 engine main body
11 injector (noise source)
12 common rail (component part, fuel supply unit)
13 fuel pipe
14 wire harness holder (component part)
14A main body
14B extension
20 engine cover
21 cover main body
21a inner surface
22 foam sound insulation member
22c front wall portion (first side)
22d rear wall portion (second side)
22e left wall portion (end)
23 engagement projection
23b engagement claw
31 first sound insulation wall
32 second sound insulation wall
33 third sound insulation wall

1-6. (canceled)

7. A sound insulation structure for an internal combustion engine, comprising:
a cover main body disposed outside of an engine main body of the internal combustion engine and covering at least a part of the engine main body; and
a foam sound insulation member made of a foam material and attached to a surface of the cover main body facing the engine main body;
wherein the foam sound insulation member covers a noise source of the engine main body and abuts the engine main body or a component part attached to the engine main body at an outer periphery thereof so as to interpose the noise source; and
wherein the engine main body or the component part includes a sound insulation wall projecting therefrom so as to shield a junction part at which the foam sound insulation member abuts or adjoins the engine main body or the component part thereof and the sound insulation wall is covered by the cover main body.

8. The sound insulation structure according to claim 7, wherein the cover main body is provided with a wall portion projecting downward from at least a part of a periphery of the cover main body.

9. The sound insulation structure according to claim 8, wherein the foam sound insulation member is provided with a wall portion projecting downward from at least a part of a periphery of the foam sound insulation member inside the wall portion of the cover main body, and a lower end of the wall portion of the foam sound insulation member abuts or adjoins the engine main body or the component part.

10. The sound insulation structure according to claim 9, wherein the sound insulation wall is provided between the wall portion of the cover main body and the wall portion of the foam sound insulation member so that a labyrinth structure is formed.

11. The sound insulation structure according to claim 9, wherein the sound insulation wall is provided inside of the wall portion of the foam sound insulation member.

12. The sound insulation structure according to claim 7, wherein the engine main body includes a cylinder block defining a plurality of cylinders along a cylinder row direction, a cylinder head attached to an end face of the cylinder block, a cylinder head cover attached to a face of the cylinder head remote from the cylinder block, and a plurality of fuel injection devices passed through the cylinder head cover and attached to the cylinder head, wherein the foam sound insulation member covers the fuel injection devices from outside, and the sound insulation wall is positioned so as to shield the junction part from outside.

13. The sound insulation structure according to claim 12, wherein at least a part of the periphery of the foam sound insulation member is provided with a wall portion projecting downward and extending in the cylinder row direction, and a lower end of the wall portion of the foam sound insulation member abuts a common rail extending in the cylinder row direction and connected to the fuel injection devices.

14. The sound insulation structure according to claim 12, wherein at least a part of the periphery of the foam sound insulation member is provided with a wall portion projecting downward and extending in the cylinder row direction, and a lower end of the wall portion of the foam sound insulation member abuts a part of the cylinder head cover extending in the cylinder row direction.

15. The sound insulation structure according to claim 12, wherein at least a part of the periphery of the foam sound insulation member is provided with a wall portion projecting downward and extending in the cylinder row direction, and a wire harness holder accommodating a wire harness connected to the fuel injection devices extends along the cylinder row direction on an outside of the engine main body, a lower end of the wall portion of the foam sound insulation member adjoining or abutting a part of the wire harness holder.

16. The sound insulation structure according to claim 15, wherein the sound insulation wall projects from the wire harness holder on an outside of the wall portion of the foam sound insulation member.

17. The sound insulation structure according to claim 15, wherein the sound insulation wall projects from the wire harness holder on an inside of the wall portion of the foam sound insulation member.

18. The sound insulation structure according to claim 7,
wherein the surface of the cover main body facing the engine main body is formed with a plurality of engagement projections each having an engagement claw at a free end thereof, while the foam sound insulation member is formed with slits for passing through the corresponding engagement projections; and
wherein a first part of the engagement projections project in a direction orthogonal to a tangential plane of a part of the cover main body adjoining the first part of the engagement projections while a second part of the engagement projections project in a direction different from that of the first part of the engagement projections.
